(19) United States
(12) Patent Application Publication
(10) Pub. No.: US 2006/0055188 A1
(43) Pub. Date: Mar. 16, 2006

(54) Load-receiving device

(76) Inventor: Michael Koch, Fellbach (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/512,070

(22) PCT Filed: Feb. 24, 2004
(86) PCT No.: PCT/EP04/01780

§ 371 Date: Oct. 21, 2004

(30) Foreign Application Priority Data
Feb. 26, 2003 (DE) 10309501.2

(51) Int. Cl. B66C 1/66

(52) U.S. Cl. 294/1.1

(57) ABSTRACT

The invention relates to a load-receiving device, particularly a stop point (10) for handling movable parts such as tower segments of a wind power station. Said load-receiving device comprises a load-receiving plate (16) that extends in the direction of a longitudinal axis (14) and is provided with grip-through points (30) which are located along the two opposite longitudinal sides (18) thereof and through which at least one fastening means (32) engages for fixing the load-receiving plate (16) to the movable part. The inventive load-receiving device further comprises a U-shaped hoisting means (34) that engages with a hoisting mechanism and can be swiveled back and forth about a first axis (pivot axis 36) while being mounted so as to be rotatable relative to the load-receiving plate (16) about a second axis (axis of rotation 38) running perpendicular to the first axis (36) by means of a rotating part (40) which is connected to the load receiving plate (16). The rotating part (40) is disposed on a transversal side (22) of the load-receiving plate (16) while the hoisting means (34) runs within an imaginary extension of the two longitudinal sides (18) of the load-receiving plate (16) when said hoisting means (34) is in a swiveled position such that as opposed to prior art the retaining bracket with the rotating part thereof is moved from the area of the longitudinal side to the area of the transversal side of the substantially cuboidal load-receiving plate, allowing potential collision points between the retaining bracket used as a hoisting means, the hoisting mechanism gripping the hoisting means, and the load that is to be moved to be definitely avoided.

The invention relates to a load receiving device, especially a slinging point for handling movable components, such as for example tower segments of a wind power plant, with a load carrying plate which extends in the longitudinal axis and which along its two opposing longitudinal sides has penetration points for passage of at least one fastening means for fixing the load carrying plate on the movable component, and with a bracket-shaped lifting means which is designed for engagement with a hoist and which can be swiveled back and forth in a first axis (swiveling axis), and in a second axis (axis of rotation) which extends transversely to it and is pivoted relative to the load carrying plate by means of a rotary part which is connected to the load carrying plate.

The pertinent load suspension devices are commercially readily available in a plurality of embodiments. In the known designs the pivoting holding bracket which is connected to the rotary part, as a lifting means for a hoist, such as a load shackle, crane hook or the like, sits on the front of the load carrying plate and consequently in the center on one of its two opposite longitudinal sides of the carrying plate which is otherwise made more or less cuboidal. With the known approach it is likewise possible to swivel the holding bracket back and forth along its swiveling axis by 180° and around the axis of rotation of the rotary part by an angle of 360°; but in spite of these movement possibilities and degrees of freedom for the holding bracket, collisions of the holding bracket with parts of the load which is to be moved take place especially when heavy loads are moved, as occur particularly in the handling of tower segments for erecting wind power plants; on the one hand this is accompanied by damage to the load itself, or damaging bending forces are induced at least in the area of the swiveling axis of the holding bracket due to the aforementioned collision.

To solve this problem, to some extent the installation crews of wind power plants have already moved to using load suspension devices which they have fabricated themselves, for example in the form of carrying plates which are screwed to the end of the respective tower segment and which by means of welded-on brackets facilitate handling, especially erection of tower segments on site; but in these approaches also, when turning from the vertical to the horizontal and during installation, damage often occurs on the components which are to be transported in the form of a tower segment; this damage can entail major repair efforts. Furthermore, for the installation crews it is often very time consuming to attach their own special contrivances on site to the respective tower segment before its erection and to remove it again.

DE 201 21 121 U1 discloses an attachment device for attachment of slinging or lashing means to the items to be transported or lashed, with a fastening element which is formed by a screw and which is used for its fastening to the respective article, with an attachment element for the slinging or lashing means and with a connecting element which connects the fastening element to the attachment element, which is pivoted around the longitudinal axis of the fastening element on a two-part sleeve which encloses the fastening element over part of its length, and which connecting element has an axial position on the sleeve which is secured by annular flanges which are located on opposing ends of the cylindrical sleeve, the connecting element in the area of the annular flanges of the sleeve being supported on the sleeve by way of one row of roller elements respectively. In the known approach the annular lifting means which forms the attachment element in all its swivel positions is located outside the sleeve which, penetrated by a screw means, is used to fix the attachment device on the slinging and lashing means. Nor can it be precluded here that installation problems can occur when using the known attachment device in the area of the handling of tower segments.

On the basis of this state of the art, the object of the invention is to devise a load suspension device which does not have the above described disadvantages and which may be mounted and removed again especially in very rapid succession on the component which is to be handled, and which makes it possible mainly to move and position the component which is to be handled, such as for example a tower segment, such that damage to the component itself is reliably avoided. This object is attained by a load suspension device with the features of claim 1 in its entirety.

In that, as specified in the characterizing part of claim 1, the rotary part is located on the transverse side of the load carrying plate and in that in the swivel position of the lifting means the latter extends within an imaginary extension of the two longitudinal sides of the load carrying plate, the holding bracket with its rotary part, in contrast to the state of the art, at any rate is displaced from the area of the longitudinal side to the area of the transverse side of the more or less cuboidal load carrying plate, with the result that potential collision sites between the holding bracket as the lifting means, the hoist which itself acts on the lifting means, and the load which is to be moved are reliably avoided. This is also promoted by the fact that it is ensured in any case by the geometrical size configuration that in one swiveling position of the lifting means said lifting means extends within an imaginary extension of the two longitudinal sides of the load carrying plate and consequently collision potential between the lifting means and the load carrying plate itself, even under load, is reliably avoided.

In one preferred embodiment of the load suspension device as claimed in the invention, the load carrying plate in the edge area has penetration points, with two fixing screws being used as the fastening means, the screw heads of which may be accommodated in depressions of the load carrying plate. With this configuration a plurality of variously dimensioned tower segments can be handled with their end flanges, on the threaded holes of which the load carrying plate is fixed by way of fixing screws. Provision is preferably made so that the screw heads of the fixing screws are secured against unintentional loosening by two covering parts which can be securely joined to the parts of the load carrying plate. This greatly increases the safety of installation.

Other advantageous embodiments are the features of the other dependent claims.

Reference will now be made to the load suspension device as claimed in the invention using one embodiment in accordance with the drawings which are schematic and not to scale.

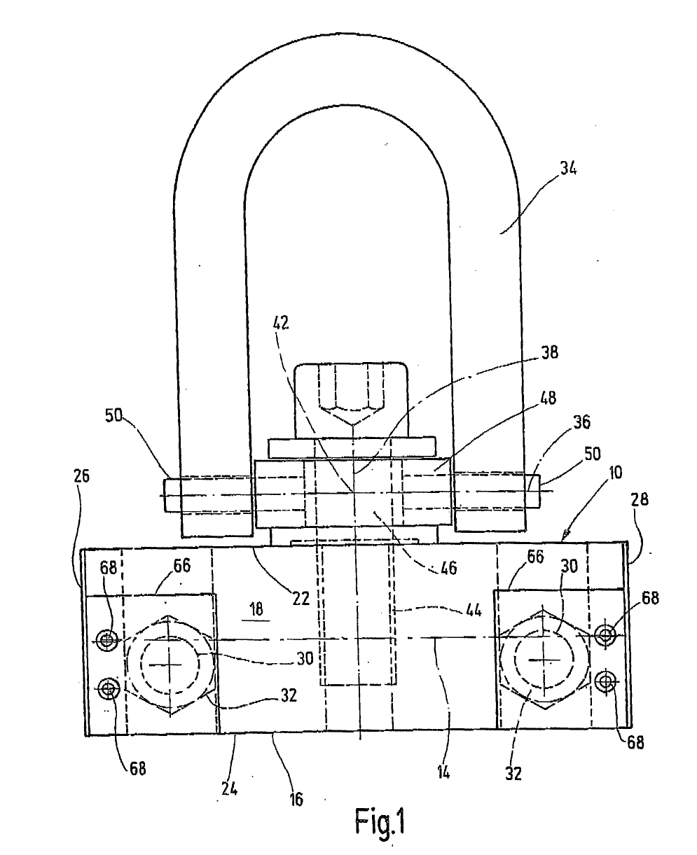

FIG. 1 shows a front view of the load suspension device;

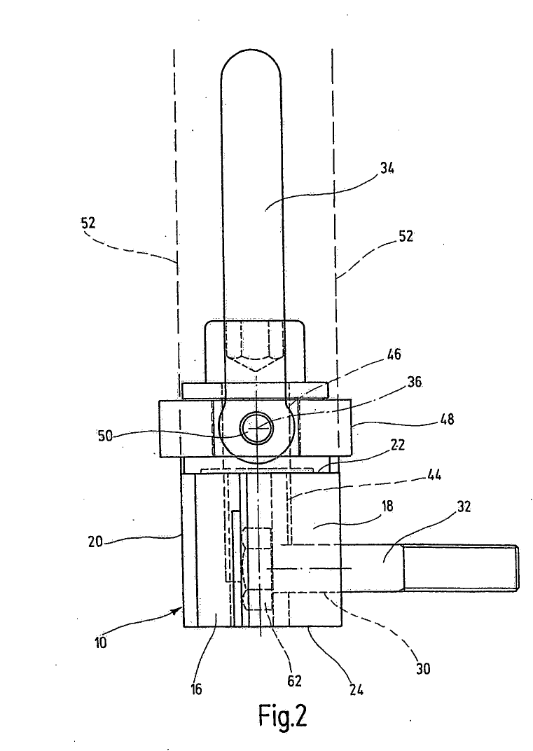

FIG. 2 shows a side face view of the load suspension device as shown in FIG. 1;

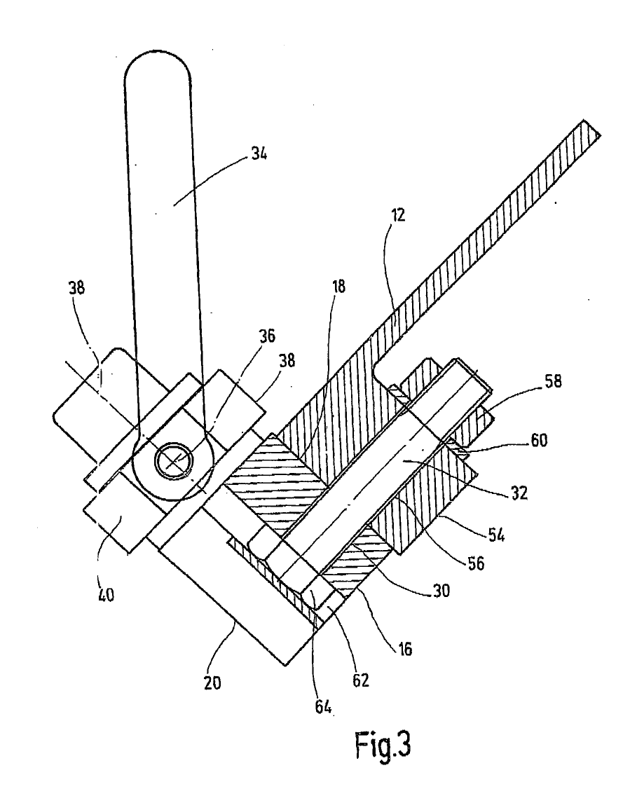

FIG. 3 shows in part in an aspect, in part in a section, the load suspension device which is fixed on the end of a tower segment of a wind power plant.

FIG. 1 shows in a front view the load suspension device, especially in the manner of a so-called slinging point 10 for handling of movable components, such as for example tower segments 12 (shown partially in FIG. 3) of a wind power plant (not shown). The load suspension device as claimed in the invention has a load carrying plate 16 which extends in the longitudinal axis 14. The load carrying plate 16 is made more or less cuboidal and extending along the longitudinal axis 14 has two opposing longitudinal sides 18, 20. Furthermore, the two longitudinal sides 18, 20 are bordered by four transverse sides 22, 24, 26, and 28 of the cuboidal load carrying plate 16. In the end area of the respective longitudinal side 18, 20 of the load carrying plate 16 there are penetration points 30 in the form of conventional holes which are provided for passage of each fastening means 32 in the form of a conventional hexagonal bolt. These hexagonal bolts as the fastening means 32 are used to fix the load carrying plate 16 on the component which is to be moved and handled, for example in the form of the tower segment 12 (compare FIG. 3).

Furthermore, the load carrying plate 16 has a bracket-shaped lifting means 34 as the holding bracket for engaging the hoist of a load lifting crane which is not detailed, for example in the form of a mobile crane or the like. The relevant hoist can be formed from a crane hook, but also from a load shackle which is connected to the load gear of the crane and which then fits into the holding bracket as the lifting means 34. The pertinent slinging and moving of loads are conventional, so that they will not be detailed here. The holding bracket as the lifting means 34 can be swiveled back and forth in a first axis (swiveling axis) 36 and, in a second axis which extends transversely to it (axis of rotation) 38, it is pivoted relative to the load carrying plate 16 by means of a rotary part 40. As illustrated in FIG. 1 in the position of the holding bracket shown there, the swiveling axis 36 extends parallel to the longitudinal axis 14 of the load carrying plate 16 and the indicated axis 38 of rotation rests vertically on the swiveling axis 36, the pertinent imaginary connecting point 42 being located outside the load carrying plate and above the transverse side 22 of the latter. Due to the swiveling axis 36 the bracket-shaped lifting means 34 can be swiveled back and forth more or less by 180° and the lifting means 34 can be turned by 360° around the vertical axis or the axis of rotation 38, and the pertinent rotary adjustment motion can be undertaken optionally in one direction for lack of a stop.

The rotary part 40 is securely connected to the load carrying plate 16 by means of a screw connection 44, more or less in the center of this screw connection 44 at least partially penetrating the load carrying plate 16 from the top of the transverse side 22. In the area of the free end of the screw bolt 46 there is a pivoted rotary sleeve 48, into which the swiveling axis 36 of the lifting means 34 fits on the end side which otherwise penetrates the two free ends of the bracket-like lifting means 34 by means of two axle pieces 50. As shown particularly in the side view in FIG. 2, the outside circumference of the rotary axis 48 extends slightly over the two longitudinal sides 18 and 20 of the load carrying plate 16. In the position of the bracket-shaped lifting means 34 which is upright when viewed in the line of sight to FIG. 2, it extends within an imaginary extension 52 of the two longitudinal sides 18, 20 of the load carrying plate 16. Consequently, the possible swiveling motion of the holding bracket 34 around its swiveling axis 36 is limited by the upper transverse side 22 of the load carrying plate 16. Thus, in two axial directions which are perpendicular to one another (swiveling axis 36 and axis of rotation 38) it is possible to freely swivel the bracket-shaped lifting means 34 without collisions occurring with the load carrying plate 16 which can be fixed on the tower segment or with the tower segment 12 itself.

The relevant relationships are shown by way of example in FIG. 3, where the tower segment 12 in the form of a conically extending hollow segment on its one free end on the inside has a flange part 54 with a transverse hole 56 through which the respective fastening means 32 in the form of a hexagonal bolt can fit, the free end of the hexagonal bolt can then be fixed by way of a lock nut 58 with a washer 60 on the flange part 54. In the fixed position which is shown in FIG. 3 then the load carrying plate 16 with its one longitudinal side 18 evenly adjoins the lower free end of the flange part 54. As shown particularly in FIG. 3, the bracket-like lifting means 34 can be freely swiveled around the swiveling axis 36 such that even in a completely vertical or horizontal arrangement of the tower segment 12 with its outside circumference no collisions occur in this respect, even when a corresponding hoist, for example in the form of a crane hook, the load shackle of load gear or the like are to act on the lifting means 34. Furthermore, the capacity of rotation around the axis of rotation 38 is preserved for the lifting means 34 so that in this respect oblique equalization is possible.

The flange part 54 of the tower segment 12 is made in the manner of a flange ring and has a plurality of fixing possibilities in the form of transverse holes 56 which have a definable radial distance from one another. The pertinent geometry can be standardized so that with a small set of load carrying plates 16 with two fastening means 32 with different spacing all important transport and handling processes can be managed. In this respect the load suspension device can be designed in the manner of a kit so that with only one component kit all forthcoming transport and handling processes can be managed on site.

As also shown particularly in FIGS. 2 and 3, the load carrying plate 16 in the edge area is provided with two groove-like depressions 62 in which the screw heads 64 of the fastening means 32 can be accommodated. These recesses 62 can in turn be covered by way of two cover parts 66 which, fixed by way of screws 64 on the load carrying plate 16, provide for the screw heads not being able to move unintentionally and in this way for the safety-relevant screw connection between the load carrying plate 16 and the flange part 52 not being able to loosen.

It has been shown that two load suspension devices on the lower end of each tower segment are sufficient to be able to move it reliably, especially to remove the tower segment from the transporter and to set it up at the site of the wind power plant. Since the load application point of the hoist by way of the bracket-like lifting means 34 acts far outside the connecting point 42 of the swiveling axis 36 and the axis of rotation 38 (compare FIG. 1) reliable transport is achieved without damage occurring on the tower segment or damaging forces for the actual load suspension device being induced.

1. A load receiving device, especially a slinging point (10) for handling movable components, such as for example tower segments (12) of a wind power plant, with a load carrying plate (16) which extends in the longitudinal axis (14) and which along its two opposing longitudinal sides (18, 20) has penetration points (30) for passage of at least one fastening means (32) for fixing the load carrying plate (16) on the movable component, and with a bracket-shaped lifting means (34) which is designed for engagement with a hoist and which can be swiveled back and forth in a first axis (swiveling axis 36), and in a second axis (axis of rotation 38) which extends transversely to it, is pivoted relative to the load carrying plate (16) by means of a rotary part (40) which is connected to the load carrying plate (16), characterized in that the rotary part (40) is located on the transverse side (22) of the load carrying plate (16) and that in the swivel position of the lifting means (34) the latter extends within an imaginary extension (52) of the two longitudinal sides (18, 20) of the load carrying plate (16).

2. The load suspension device as claimed in claim 1, wherein the load carrying plate (16) in the edge area has penetration points (30) and wherein as the fastening means (32) two fixing screws are used, with screw heads (64) which can be accommodated in depressions (62) of the load carrying plate (16). heads (64) of the fixing screws are secured against unintentional loosening by two covering parts (66) which can be securely joined to the parts of the load carrying plate (16).

4. The load suspension device as claimed in claim 1, wherein the load carrying plate (16) is made cuboidal, wherein the rotary part (40) is fixed by way of a screw section (46) in the load carrying plate (16) on the transverse side (22) and wherein the rotary section (48) sits on this transverse side (22) and enables rotation of the lifting means (34) by 360°.

5. The load suspension device as claimed in claim 1, wherein the swiveling motion of the lifting means (34) around its swiveling axis (36) is limited by the side surface of the transverse side (22) of the load carrying plate (16).

6. The load suspension device as claimed in claim 1, wherein the lifting means (34) has two elongated legs, on the respective free end of which the swiveling axis (36) penetrates them and is part of the rotary part (40).
